(19) United States
(12) Patent Application Publication
(10) Pub. No.: US 2005/0286479 A1
(43) Pub. Date: Dec. 29, 2005

(54) Business method and apparatus for providing wireless telecommunication services for mobile applications

(76) Inventor: Eric Spencer, Williston, VT (US)

Correspondence Address: Eric Spencer, 86 Fairway Drive, Williston, VT, 05495, US

(21) Appl. No.: 10/881,075

(22) Filed: Jun. 29, 2004

(51) Int. Cl. H04Q 7/24

(52) U.S. Cl. 370/338

(57) ABSTRACT

A business method and telecommunications system is described which is specifically adapted to provide wireless communication services such as internet access as a vehicle moves down a predefined transportation corridor such as a highway or railroad tracks.

### BACKGROUND OF THE INVENTION

This application relates to a business method and apparatus for providing wireless telecommunications specifically adapted for use in mobile applications, for example, when a client is in a moving vehicle such as a car, a truck, a bus, a train, a plane or any other moving vehicle.

Typical wireless telecommunication systems such as cell phone systems attempt to cover large geographic areas with large towers, each tower containing a plurality of sector antennas which transmit high power signals to receive and send signals to/from a client device such as a cell phone user. These large towers and high power wireless transmission systems are extremely expensive to build and maintain.

In contrast, the present application teaches a telecommunication system particularly suited for use along a transportation corridor, for example, a railway car as it travels down the tracks or a car as it travels down a highway. This telecommunication system provides various client services such as internet access, voice-over-internet-protocol services and other telecom services to passengers of vehicles as they travel along a transportation corridor.

### SUMMARY OF THE INVENTION

According to one aspect of the present invention, a wireless telecommunication system is provided comprising a client device configured to send and receive telecommunication signals. A plurality of transceiver sites are positioned along a path traveled by the client device, each transceiver site being in communication with the client device as the client device passes within range of the transceiver site and each transceiver site is in communication with at least one other transceiver site wherein there is also provided at least one connection to a communications backbone which is connected to a transceiver site.

In another aspect of the invention, a device for providing wireless internet service for client devices wherein the client devices are disposed in a moving railway car is provided comprising an enclosure configured to house and protect a predetermined set of electronic components and the enclosure is configured to attach to a utility pole. Also provided is a central processing unit disposed in the enclosure for program execution and control of the device. A computer readable memory for storage of a control program is provided and the control program is read and executed by the central processing unit. A first wireless transceiver configured to communicate with a plurality of client devices under the control of the control program is provided and a second wireless transceiver configured to communicate with any adjacent device under the control of the control program is also provided. A network interface is provided which is configured to receive a wired connection to a telecommunications backbone.

In a further aspect of the invention, a system for providing wireless internet access to passengers of a train as the train travels along the tracks is provided that comprises a plurality of wireless repeaters disposed along the tracks, the repeaters being in wireless communication with a plurality of wireless client devices associated with the passengers, wherein each wireless repeater is in communication with any adjacent wireless repeaters in a chain arrangement and at least one wireless repeater is in communication with the internet.

In yet another aspect of the present invention a business method of providing wireless telecommunication services for passengers of a train is provided comprising the steps of affixing a plurality of transceiver sites along a path traveled by the train with each transceiver site configured to communicate with a client device associated with a passenger as the train passes within range of a respective transceiver site. Each transceiver site is in communication with at least one other transceiver site. Connecting at least one said transceiver site to the internet and establishing a wireless connection between at least one said transceiver site and the client device. Capturing data to determine the identity of the passenger associated with the client device and then verifying the identity of the passenger associated with the client device by comparing the captured data to data contained in a database. Maintaining the wireless connection between the client device and at least one transceiver site as the train travels down the tracks.

### BRIEF DESCRIPTION OF THE DRAWINGS

FIG. 1 is a simplified plan view of the wireless system in accordance with one embodiment of the present invention;

FIG. 2 is a simplified cross sectional view of a wireless repeater in accordance with one embodiment of the present invention;

FIG. 3 is a simplified top view in accordance with one embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, a wireless communication system is provided that allows for the deployment of wireless repeaters along transportation corridors and provides uninterrupted internet access to client devices as the client device travels along the transportation corridor. A typical transportation corridor would include for example a road, a highway, train tracks or even established routes of aircraft and boats.

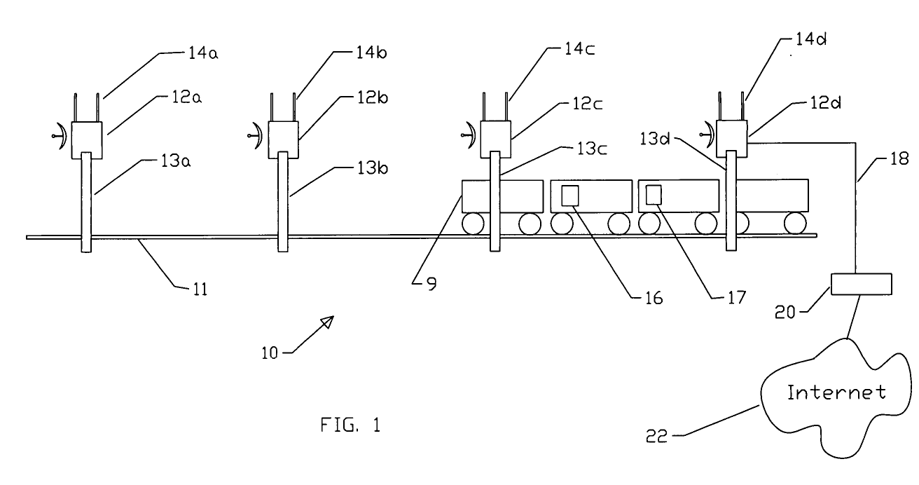

Referring first to FIG. 1, a wireless communication system 10 is shown in accordance with one aspect of the present invention. FIG. 1 depicts a train 9 made up of multiple interconnected train cars with for example a pair of client devices 16 and 17 disposed therein. Typically, the client devices 16 and 17 may be laptop computers having wireless communication capabilities of their own. Recently, wireless interfaces such as those that attach to a laptop's USB port or PCMCIA card port have become quite popular. Typically these wireless interfaces are IEEE 802.11 compliant devices which typically communicate in the unlicensed ISM frequency band of approximately 2.4 Ghz and can support up to a 54 Mps data transmission rate.

Disposed along the train tracks 11 may be a plurality of utility poles 13a, 13b, 13c and 13d. Disposed on each of these utility poles is a respective wireless repeater 12a, 12b, 12c, and 12d. Associated with each wireless repeater may be antennas 14a, 14b, 14c and 14d. Each wireless repeater 12 is positioned along the tracks 11 such that it may communicate with any adjacent wireless repeater and maintain complete, uninterrupted coverage of the client devices 16 and 17 as they travel down the tracks 11. Depending on the capabilities of the repeaters and the terrain along the tracks, each repeater could be several miles or more apart, therefore, not every pole will have a repeater.

While this arrangement only depicts four repeaters 12 along the tracks 11, many such repeaters 12 may be located along the tracks to cover hundreds of miles of track. A network connection 18 through a router 20 is shown attached to at least one of the repeaters 12d, which provides the connection to the internet 22 for all the repeaters and allows the client devices 16 and 17 to connect to the internet wirelessly through the network of repeaters. More than one connection to the internet backbone may be provided in order to reduce network latency. It should also be mentioned that while the internet connection in FIG. 1 is shown as hard wired to a repeater 12d that is located adjacent to the tracks 11, this connection could easily be a wireless connection to a router 20 that is remote from the tracks.

With each wireless repeater 12 in communication with any adjacent repeater, a chain like communication network is provided which allows all repeaters to communicate with the internet connection thereby providing uninterrupted internet connection to the client devices 16 and 17 as they travel down the tracks.

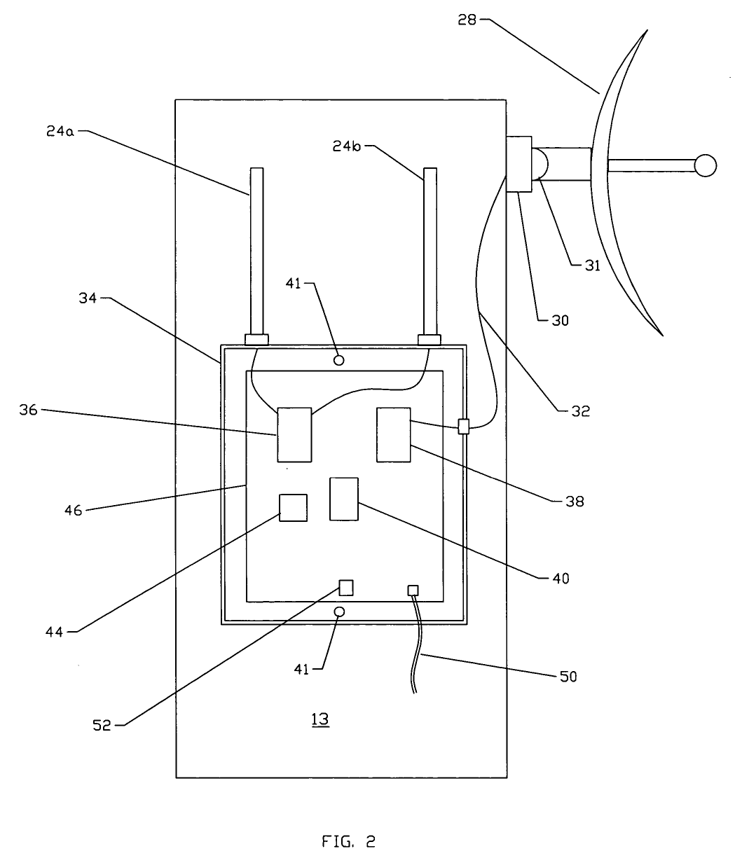

Turning now to FIG. 2, the configuration and operation of the wireless repeater will be described in more detail. An enclosure 34 may be affixed to a utility pole 13 by a pair of fasteners 41 located inside the enclosure. Obviously, other attachment arrangements are possible, and all such arrangements are fully contemplated by the present invention. Housed inside the enclosure 34 may be an electronics board 46 which is configured to retain and provide power to various electronic components. A Central Processing Unit 40 may be disposed on the board 46 which reads and executes program instructions located in ROM 44 also disposed on the board 46. In one embodiment, the ROM 44 is a 64 MB compact flash card which has been formatted to contain the control program. A first radio transceiver 36 may be disposed on board 46, first transceiver 36 may be configured to communicate with any adjacent repeaters 12 to provide a flow of data to and from the client devices 16 and 17 back to the internet connection 22 under the control of CPU 40 in accordance with the control program.

In one embodiment, the first radio transceiver 36 may be a mini-PCI IEEE 802.11b compliant device with a transmit power of 200 mW. One such device is made by a company named Senao and it provides the ability to attach two antennas 24a and 24b to a single transceiver to enhance the sensitivity and increase the effective range of the radio transceiver by using antenna diversity. This transceiver may plug into a mini-PCI slot located on board 46.

A second radio transceiver 38 may also be disposed on board 46 similar to first radio transceiver. However, the purpose of this radio transceiver is to communicate directly with the client device 16 and 17. Second radio transceiver 38 is configured to maintain a continuous wireless connection with a plurality of client devices as the client devices enter and remain in the effective range of the second transceiver. In an effort to increase the signal strength and effective range of the second transceiver 38, a high gain antenna, such as a parabolic grid antenna 28 may be in communication with the second transceiver 38. The beam form of the antenna 28 may be chosen to specifically maintain wireless communication with the client devices between each repeater site. Using a high gain antenna 28 allows the signal to be concentrated in the area of the traveling vehicle and thereby overcome any attenuation that may occur due to the client device being located inside the vehicle.

As shown in FIG. 2, a low loss cable 32 may be interconnected between the antenna 28 and the second transceiver 38 and the antenna 28 may be disposed on the pole 13 by a rod or pipe 30. The positioning of the antenna 28 may be adjusted by a pivot 31 which allows the beam form to be adjusted for maximum coverage.

A network interface 52 such as a typical CAT 5 interface may also be disposed on board 46 which allows another network device to connect to the repeater 12 for diagnostic or other purposes. In the event the internet connection 22 is hard wired to the system, this may be where that connection may occur.

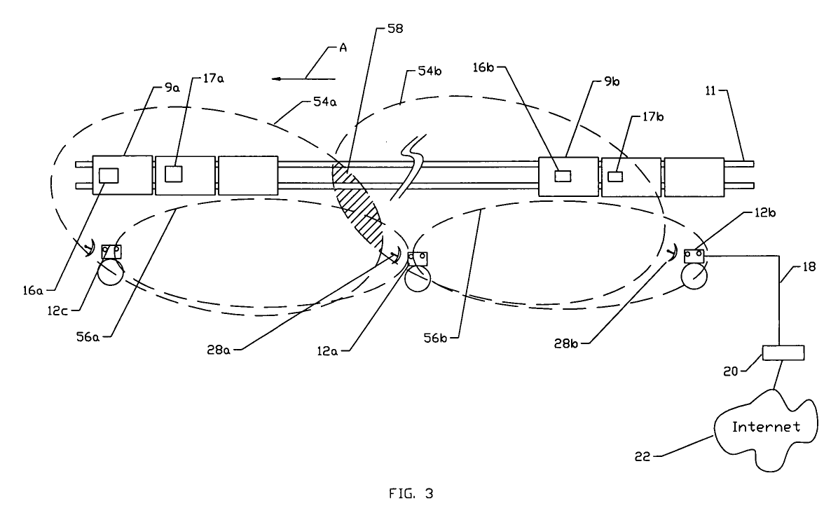

Referring now to FIG. 3, a top view of a section of railroad track is shown with a telecommunication system 10 in accordance with one aspect of the present invention. A pair of trains 9a and 9b are shown traveling in the direction of arrow A down the same set of railroad tracks 11. As shown (but not by limitation), each train 9a and 9b are in range of two different repeater stations 12a and 12b. In this arrangement, client devices 16a and 17a are in communication with repeater 12a because they are located in the beam 54a as projected by high gain antenna 28a. Client devices 16b and 17b are in communication with repeater 12b because they are located in the beam 54b as projected by high gain antenna 28b. Due to beam form 56a and 56b, repeater 12b is in communication with both repeaters 12c and 12a and this allows data from the respective client devices to be relayed to the internet 22. It should be mentioned that in order to reduce interference, first radio transceiver 36 and second radio transceiver 38 are configured to operate at different radio frequencies. With this configuration, network latency may be reduced and reliability of the wireless connections will be improved.

In order to maintain an uninterrupted connection between the client devices and the internet, an overlap 58 may be provided in the beam forms generated by the high gain antennas 54a and 54b. The overlap 58 is configured to allow client devices to maintain a wireless connection as the train travels between the various repeaters 12. The control program may be specifically configured to allow a client device to associate with a new repeater before it losses a connection to the current repeater. This is often referred to as “roaming capability”.

This arrangement of repeaters 12a-c may therefore be easily repeated along the tracks 11 to cover many miles of track. It may be advantageous to provide more than one internet connection to the system to improve network performance. This may be easily done by installing multiple internet connections to selected repeaters 12 which are spaced along the tracks.

With this configuration, wireless telecommunication services such as internet access can be seamlessly provided to vehicle passengers as they travel to their destination. In one embodiment of the present invention, a client device 16 associates and wirelessly communicates with a repeater site 12. The repeater site 12 delivers to the client device 12 a log in screen and asks for a username and password. The passenger associated with the client device 12 enters a username and a password and wirelessly transmits this to a repeater site 12. This information is relayed through the necessary repeater sites 12 until it reaches the internet connection 22 and through the internet the username and password are compared to information contained in a database that may be remote from the repeater sites. If the username and password are confirmed, the client device 16 is granted access to surf the internet or use other telecommunication services. In this way, access is only granted to client/users that have an account. This also allows the system to track usage by client device/user for proper accounting and billing purposes. An alternative method to grant access to client devices may include receiving and comparing the MAC address of the client device attempting to log on. Each wireless interface is hard coded with a unique MAC address which may be used to allow or deny access to the system.

It should be understood, of course, that the foregoing relates to preferred embodiments of the invention and that modifications may be made without departing from the spirit and scope of the invention as set forth in the following claims.

1. A wireless telecommunication system configured to communicate with a client device comprising:
a plurality of transceiver sites positioned along a path traveled by said client device, each transceiver site being in communication with the client device as the client device passes within range of said transceiver site and each transceiver site is in communication with at least one other transceiver site; and,
at least one said transceiver site is in communication with a communications backbone.

2. The wireless telecommunication system of claim 1, wherein the client device is disposed in a vehicle selected from the group consisting of a car, a railroad car, a subway, a truck, a boat, a bus, a bike and a plane.

3. The wireless telecommunication system of claim 1, wherein said client device is a laptop computer having a wireless interface.

4. The telecommunication system of claim 3, wherein the wireless interface is IEEE 802.11 compliant.

5. The wireless telecommunication system of claim 1, wherein said plurality of transceiver sites are attached to poles along a path traveled by said client device.

6. The wireless telecommunication system of claim 5, wherein said path traveled by said client device is defined by a set of railroad tracks.

7. The wireless telecommunication system of claim 1, wherein each said transceiver site is further comprised of:
an electronics board executing a control program configured to control the operation of the transceiver site;
a first radio transceiver in communication with said electronics board, said radio transceiver configured to receive and send telecommunication signals;
a first antenna in communication with said first radio transceiver, said first antenna configured to send signals from said first radio transceiver and receive signals from a plurality of client device;
a second radio transceiver in communication with said electronics board, said second radio transceiver configured to receive and send telecommunication signals;
a second antenna in communication with said second radio transceiver, said second antenna configured to send signals to any adjacent transceiver site and receive signals from any adjacent transceiver site.

8. The wireless telecommunication system of claim 7, wherein the client device maintains uninterrupted communications with said telecommunication backbone as the client device moves between adjacent transceiver sites.

9. The wireless telecommunication system of claim 7, wherein said first antenna is one selected from the group consisting of a parabolic antenna, a flat panel antenna, an omnidirectional antenna, a yagi antenna and a patch antenna.

10. A device for providing wireless internet service for client devices wherein the client devices are disposed in a moving railway car, comprising:
an enclosure configured to house and protect a plurality of electronic components, said enclosure being configured to be attached along a path defined by the moving railway car;
a central processing unit disposed in said enclosure for program execution and control of the device;
computer readable memory for storage of a control program, said control program being read and executed by said central processing unit;
a first wireless transceiver configured to communicate with a plurality of client devices under the control of said control program;
a second wireless transceiver configured to communicate with an any adjacent device under the control of said control program; and
a network interface configured to receive a wired connection to a telecommunications backbone.

11. The device for providing wireless internet service for client devices of claim 10, further comprising a first antenna in communication with said first wireless transceiver, wherein said first antenna beam is aligned with the railroad tracks to improve the effective communication range of the device as the railway car travels down the tracks.

12. The device for providing wireless internet service for client devices of claim 11, further comprising a second antenna in communication with said second wireless transceiver, wherein said second antenna beam is aligned with the any adjacent device that is to be communicated with.

13. The device for providing wireless internet service for client devices of claim 11, wherein said first antenna is one selected from the group consisting of a flat panel antenna, a patch antenna, an omni-directional antenna, a parabolic dish antenna, a yagi antenna and a dish antenna.

14. The device for providing wireless internet service for client devices of claim 11, wherein said second antenna is one selected from the group consisting of a flat panel antenna, a patch antenna, an omni-directional antenna, a parabolic dish antenna, a yagi antenna and a dish antenna.

15. A system for providing wireless internet access to passengers of a train as the train travels along the tracks comprising a plurality of wireless repeaters disposed along the tracks, said repeaters being in wireless communication with a plurality of wireless client devices associated with the passengers, wherein each wireless repeater is in communication with any adjacent wireless repeaters in a chain arrangement and at least one wireless repeater is connected to the internet.

16. The system of claim 15, wherein said repeaters are configured to allow said client devices to move between adjacent repeaters without dropping the internet connection as the client device moves along the tracks.

17. The system of claim 15, wherein each wireless repeater further comprises:
a first radio transceiver configured to wirelessly communicate with said client devices; and,
a second radio transceiver configured to wirelessly communicate with at least one adjacent repeater.

18. The system of claim 17, further comprising:
a first antenna in communication with said first radio transceiver, wherein said first antenna is one selected from the group consisting of a parabolic dish antenna, a flat panel antenna, a yagi antenna and a patch antenna, and wherein the beam pattern of said first antenna is aimed along the tracks for communication with said client devices.

19. The system of claim 18 further comprising a pair of omnidirectional antennas in communication with said second radio transceiver, wherein said pair of omnidirectional antennas are configured to enhance signal reception through the use of antenna diversity.

20. The system of claim 19, wherein said repeaters are disposed on a utility pole adjacent the train tracks.

21. A business method of providing wireless telecommunication services for passengers of a train comprising the steps of:
affixing a plurality of transceiver sites along a path traveled by the train, each transceiver site configured to communicate with a client device associated with a passenger as the train passes within range of a respective transceiver site and each transceiver site is in communication with at least one other transceiver site;
connecting at least one said transceiver site to the internet;
establishing a wireless connection between at least one said transceiver site and the client device;
capturing data to determine the identity of the passenger associated with the client device;
verifying the identity of the passenger associated with the client device by comparing the captured data to data contained in a database; and,
maintaining the wireless connection between the client device and at least one transceiver site as the train travels down the tracks.

22. The business method of claim 21, wherein the step of capturing data to determine the identity of the passenger further comprises the steps of:
wirelessly transmitting to the client device a log in screen where the passenger enters a username and password; and,
transmitting the username and password to at least one said transceiver site.

23. The business method of claim 21, wherein the step of capturing data to determine the identity of the passenger is comprised of the step of capturing the MAC address associated with the client device.

24. The business method of claim 21, further comprising the steps of:
tracking the amount of time each client spends in communication with said transceiver sites; and,
billing the passenger associated with the client device at a predetermined rate for the time spent.

25. The business method of claim 21, wherein said transceiver site further comprises:
an electronics board executing a control program configured to control the operation of the transceiver site;
a first radio transceiver in communication with said electronics board, said radio transceiver configured to receive and send telecommunication signals;
a first antenna in communication with said first radio transceiver, said first antenna configured to send signals from said first radio transceiver and receive signals from a plurality of client device;
a second radio transceiver in communication with said electronics board, said second radio transceiver configured to receive and send telecommunication signals;
a second antenna in communication with said second radio transceiver, said second antenna configured to send signals to any adjacent transceiver site and receive signals from any adjacent transceiver site.

26. The business method of claim 21, wherein the client device is a laptop computer having a wireless interface.

27. The business method of claim 26, wherein the wireless interface is IEEE 802.11 compliant.

28. The business method of claim 21, wherein said plurality of transceiver sites are attached to poles disposed in close proximity to the train tracks.
